(19) United States
(12) Patent Application Publication
(10) Pub. No.: US 2007/0166475 A1
(43) Pub. Date: Jul. 19, 2007

(54) Treating textiles with emulsions containing silicone resins

(76) Inventors: Frances Fournier, Birch Run, MI (US); Yihan Liu, Midland, MI (US); Virginia O'neil, Midland, MI (US); Randall Schmidt, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 10/588,246

(22) PCT Filed: Feb. 4, 2005
(86) PCT No.: PCT/US05/04283

§ 371 Date: Aug. 2, 2006

Related U.S. Application Data
(60) Provisional application No. 60/541,657, filed on Feb. 4, 2004.

(51) Int. Cl. B05D 1/36; D06M 15/643

(52) U.S. Cl. 427/412; 252/8.57; 252/8.61; 524/501

(57) ABSTRACT

Fibers, textiles, and leather are treated by applying to the fibers, textiles, and leather 0.1-15 weight percent based on the weight of the fibers, textiles, or leather of a treatment composition. The treatment composition consists of a blend containing a silicone resin component and a fluorocarbon component. The fluorocarbon component can be at least one of an emulsion containing a fluoroalkyl acrylate copolymer or an emulsion containing a fluorinated polyurethane. The silicone resin component is at least one of (i) an aminofunctional silicone resin, (ii) an emulsion containing an aminofunctional silicone resin, (iii) a carbinol functional silicone resin, (iv) an emulsion containing a carbinol functional silicone resin, (v) an epoxy functional silicone resin, or (vi) an emulsion containing en epoxy functional silicone resin.

### CROSS REFERENCE TO RELATED APPLICATIONS

Not applicable.

### FIELD OF THE INVENTION

This invention is related to the treatment of textiles with blends of certain silicone resins and/or emulsions containing silicone resins, in combination with emulsions containing a fluoroalkyl acrylate copolymers or emulsions containing fluorinated polyurethanes. Textiles treated with such blends exhibit superior hand properties.

### BACKGROUND OF THE INVENTION

The use of silicones as water repellency agents has found ever-increasing acceptance in the textile industries over the years, as compared with other highly hydrophobic substances such as paraffin and other waxes. Silicones exhibit a number of advantages in such applications including the fact that (i) they do not possess a fatlike nature which has a good effect on the finish of the fabric; (ii) they are fixed on the fiber in such a way that they withstand fairly well washing treatment with solvents; (iii) they are substantially resistant to chemicals and weathering; and (iv) they have a very considerable softening and smoothing effect on the textile.

For example, reference may be had to U.S. Pat. No. 4,781,844 (Nov. 1, 1988), U.S. Pat. No. 4,978,462 (Dec. 18, 1960), and U.S. Pat. No. 6,171,515 (Jan. 9, 2001), for a description of the general state of the art. The '515 patent in particular provides a detailed overview on the use of various silicones in the textile industry.

The present invention, in particular, is directed to the use of certain aminofunctional silicone resins, carbinol functional silicone resins, epoxy functional silicone resins, and emulsions containing such resins, in the treatment of textiles. When combined with emulsions containing fluoroalkyl acrylate copolymers or emulsions containing fluorinated polyurethanes, the silicone resins and emulsions containing the silicone resins have been found to exhibit superior hand properties, while maintaining stain and water resistance and stain release properties.

### SUMMARY OF THE INVENTION

The invention is directed to a method of treating fibers, textiles, or leather comprising applying to fibers, textiles, or leather, 0.1-15 weight percent based on the weight of the fibers, textiles, or leather of a treatment composition comprising a blend containing a silicone resin component and a fluorocarbon component, the fluorocarbon component comprising one or at least one of an emulsion containing a fluoroalkyl acrylate copolymer or an emulsion containing a fluorinated polyurethane, the silicone resin component comprising one or at least one of (i) an aminofunctional silicone resin, (ii) an emulsion containing an aminofunctional silicone resin, (iii) a carbinol functional silicone resin, (iv) an emulsion containing a carbinol functional silicone resin, (v) an epoxy functional silicone resin, and (vi) an emulsion containing an epoxy functional silicone resin.

Significant improvements can be realized using coatings containing the blended compositions of the invention. For example, certain coatings of such blended compositions provide improvement in hand over uncoated fabrics, and over fabrics coated with only the flurocarbon component. In addition, certain of the coatings are also capable of imparting to the fabric 100 percent water repellency.

These and other features of the invention will become apparent from a consideration of the detailed description.

### BRIEF DESCRIPTION OF THE DRAWING

Not applicable.

### DETAILED DESCRIPTION OF THE INVENTION

The details of each of the various components of treatment compositions according to the invention is explained below.

### The Aminofunctional Silicone Resin

The aminofunctional silicone resin is a resin comprising the units:
(R₃SiO_{1/2})ₐ (i)
(R₂SiO_{2/2})_{b} (ii)
(RSiO_{3/2})_{c} and (iii)
(SiO_{4/2})_{d} (iv)
wherein R is independently an alkyl group, an aryl group, or an aminofunctional hydrocarbon group; a has a value of greater than zero to 0.5; b has a value of zero to 0.4; c has a value of greater than zero to 0.93; d has a value of less than 0.3; and the sum of a+b+c+d is 1.

In terms of standard silicone chemistry, the basic units of silicones including silicone resins consist of the unit (R₃SiO_{1/2}) termed the monofunctional or M unit; the unit (R₂SiO_{2/2}) termed the difunctional or D unit; the unit (RSiO_{3/2}) termed the trifunctional or T unit; and the unit (SiO_{4/2}) termed the tetrafunctional or Q unit. In the present invention, M units are needed in order to provide shelf stability for the aminofunctional silicone resin.

In the aminofunctional silicone resin in particular, the alkyl groups of R are illustrated by methyl, ethyl, propyl, butyl, hexyl, octyl, decyl, dodecyl, hexadecyl, and octadecyl, with the alkyl group typically being methyl. The aryl groups are illustrated by phenyl, naphthyl, benzyl, tolyl, xylyl, xenyl, methylphenyl, 2-phenylethyl, 2-phenyl-2-methylethyl, chlorophenyl, bromophenyl and fluorophenyl, with the aryl group typically being phenyl. The aminofunctional hydrocarbon group is illustrated by —R⁸NHR⁹ or —R⁸NHR⁸NHR⁹, wherein each R⁸ is independently a divalent hydrocarbon group having at least 2 carbon atoms, and R⁹ is hydrogen or an alkyl group.

Each R⁸ is typically an alkylene group having from 2 to 20 carbon atoms. R⁸ is illustrated by groups such as —CH₂CH₂—, —CH₂CH₂CH₂—, —CH₂CHCH₃—, —CH₂CH₂CH₂CH₂—, —CH₂CH(CH₃)CH₂—, —CH₂CH₂CH₂CH₂CH₂—, —CH₂CH₂CH₂CH₂CH₂CH₂—, —CH₂CH₂CH(CH₂CH₃)CH₂CH₂CH₂—, —CH₂CH₂CH₂CH₂CH₂CH₂CH₂CH₂—, and —CH₂CH₂CH₂CH₂CH₂CH₂CH₂CH₂CH₂CH₂—. The alkyl groups R⁹ are the same as illustrated above for R. When R⁹ is an alkyl group, it is typically methyl.

Some examples of suitable aminofunctional hydrocarbon groups are —CH₂CH₂NH₂, —CH₂CH₂CH₂NH₂, —CH₂CHCH₃NH, —CH₂CH₂CH₂CH₂NH₂, —CH₂CH₂CH₂CH₂CH₂NH₂, —CH₂CH₂CH₂CH₂CH₂CH₂NH₂, —CH₂CH₂NHCH₃, —CH₂CH₂CH₂NHCH₃, —CH₂(CH₃)CHCH₂NHCH₃, —CH₂CH₂CH₂CH₂NHCH₃, —CH₂CH₂NHCH₂CH₂NH₂, —CH₂CH₂CH₂NHCH₂CH₂CH₂NH₂, —CH₂CH₂CH₂CH₂NHCH₂CH₂CH₂NH₂, —CH₂CH₂NHCH₂CH₂NHCH₃, —CH₂CH₂CH₂NHCH₂CH₂CH₂NHCH₃, —CH₂CH₂CH₂CH₂NHCH₂CH₂CH₂CH₂NHCH₃, and —CH₂CH₂NHCH₂CH₂NHCH₂CH₂CH₂CH₃.

The aminofunctional silicone resins are illustrated by the following compositions:
I. aminofunctional silicone resins comprising the units:
   ((CH₃)₃SiO_{1/2})ₐ (i)
   (C₆H₅(CH₃)SiO_{2/2})_{b} (ii)
   ((CH₃)RSiO_{2/2})_{b} (iii)
   (C₆H₅SiO_{3/2})_{c}, (iv)
II. aminofunctional silicone resins comprising the units:
   ((CH₃)₃SiO_{1/2})ₐ (i)
   ((CH₃)RSiO_{2/2})_{b} (ii)
   (RSiO_{3/2})_{c} (iii)
   (C₆H₅SiO_{3/2})_{c}, (iv)
III. aminofunctional silicone resins comprising the units:
   ((CH₃)₃SiO_{1/2})ₐ (i)
   ((CH₃)RSiO_{2/2})_{b} (ii)
   (C₆H₅SiO_{3/2})_{c}, and (iii)
IV. aminofunctional silicone resins comprising the units:
   ((CH₃)₃SiO_{1/2})ₐ (i)
   (C₆H5(CH₃)SiO_{2/2})_{b} (ii)
   ((CH₃)RSiO_{2/2})_{b} (iii)
   (C₆H₅SiO_{3/2})_{c} (iv)
   (SiO_{4/2})_{d}, (v)
   wherein a, b, c, and d, are as defined above, and R is —CH₂CH₂CH₂NH₂.

In the aminofunctional silicone resin, typically a has a value of 0.1-0.3; b has a value of 0-0.2; c has a value of 0.5-0.7; and d is zero. Generally, 0.1-10 mole percent of the silicon atoms contain aminofunctional hydrocarbon groups in the units (i), (ii), or (iii); the —NH— equivalent weight of the aminofunctional silicone resin is 700-4,000; and 0-5 weight percent of unit (ii) are Me₂SiO_{2/2} units in the aminofunctional silicone resin. As used herein, —NH— equivalent weight means the weight of material that contains one atomic weight of amine hydrogen.

Aminofunctional silicone resins can be prepared by the hydrolytic polycondensation of alkoxysilanes by one of two methods. In one method, the hydrolysis of non-aminofunctional alkoxysilanes can be accomplished via catalysis with a strong acid, followed by addition of an aminofunctional silane, and the base-catalyzed equilibration of these species, to yield an aminofunctional silicone resin. In the other method, the entire hydrolysis can be run under base-catalyzed conditions, with aminofunctional alkoxysilane(s) present from the start. In both methods, the hydrolysis is followed by distillation to remove the by-product alcohol, filtration, and removal of any solvent to provide the product.

Aminofunctional silicone resins can also be manufactured by hydrolyzing 20-50 weight percent of an aryltrialkoxysilane, and/or an arylalkyldialkoxysilane, catalyzed by 0-0.05 weight percent with trifluoromethanesulfonic acid (TFMSA), with 0-10 weight percent deionized water, followed by distillation to remove the by-product alcohol. Up to 35 weight percent of hexamethyldisiloxane (HMDS), up to 10 weight percent water, and optionally, up to 40 weight percent toluene, is then added, and the mixture is heated to 50-60° C., optionally followed by distillation to remove any volatile substances. Up to 20 weight percent of γ-aminoalkyltrialkoxysilane (APTES) or γ-aminoalkyldialkoxyalkylsilane are added, along with up to 10 weight percent of water, followed by distillation to remove the alcohol. Up to 40 weight percent of toluene can be added if it was not added earlier, up to 10 weight percent of water, and optionally, a catalytic amount necessary to make 0-0.1 weight percent KOH, of 1.0 N aqueous potassium hydroxide, is added, and water is removed via an azeotrope. If added, the hydroxide is neutralized with 1.0 N aqueous HCl or acetic acid, and water is again removed via an azeotrope. The mixture is filtered, and the solvent is removed to yield an aminofunctional silicone resin. In this scenario, typically, the aryl group is phenyl, the alkyl group is methyl, the alkoxy group is either methoxy or ethoxy, and the amino group is the aminofunctional hydrocarbon group described above.

The Carbinol Functional Silicone Resin

The carbinol functional silicone resin is a resin composition comprising the units:
(R¹₃SiO_{1/2})ₑ (i)
(R²₂SiO_{2/2})_{f} (ii)
(R³SiO_{3/2})_{g} (iii)
and
(SiO_{4/2})h (iv)
wherein R¹ and R² are independently a hydrogen atom, an alkyl group having 1-8 carbon atoms, an aryl group, a carbinol group having at least 3 carbon atoms and being free of aryl groups, or an aryl containing carbinol group having at least 6 carbon atoms; R³ is an alkyl group having 1-8 carbon atoms or an aryl group; e has a value of less than 0.6; f has a value of zero to 0.4; g has a value of greater than zero; h has a value of less than 0.5; the sum of e+f+g+h is equal to one, and provided that when each R² is methyl, the value of f is less than 0.3.

As used herein, the phrase carbinol group is considered as being any group containing at least one carbon-bonded hydroxyl (COH) group. Thus, the carbinol group may contain more than one COH group, such as for example: 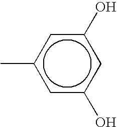
The alkyl groups in the carbinol functional silicone resin are illustrated by methyl, ethyl, propyl, butyl, pentyl, hexyl, and octyl, with the alkyl group typically being methyl. The aryl groups are illustrated by phenyl, naphthyl, benzyl, tolyl, xylyl, xenyl, methylphenyl, 2-phenylethyl, 2-phenyl-2-methylethyl, chlorophenyl, bromophenyl and fluorophenyl, with the aryl group typically being phenyl.

The carbinol group having at least 3 carbon atoms and being free of aryl groups is illustrated by the group R⁴OH where R⁴ is a divalent hydrocarbon group having at least 3 carbon atoms, or a divalent hydrocarbonoxy group having at least 3 carbon atoms. R⁴ is illustrated by alkylene groups such as —(CH₂)_{z}— where z is 3-10, —CH₂CH(CH₃)—, —CH₂CH(CH₃)CH₂—, —CH₂CH₂CH(CH₂CH₃)CH₂CH₂CH₂—, and —OCH(CH₃)(CH₂)_{z}—, where z is 1-10.

The aryl containing carbinol group having at least 6 carbon atoms is illustrated by R⁵OH where R⁵ is an arylene group such as —(CH₂)_{z′}, C₆H₄— where z′ is 0-10, —CH₂CH(CH₃)(CH₂)_{z′}C₆H₄— where z′ is 0-10, and —(CH₂)_{z}C₆H4(CH₂)_{z}— where z is 1-10. The aryl-containing carbinol groups typically have 6-14 atoms.

In the carbinol functional silicone resin, typically e is 0.3-0.5, f is 0-0.2, g is 0.5-0.8, and h is zero. The carbinol functional silicone resin is illustrated by the following compositions:
I. carbinol functional silicone resins comprising the units:
   ((CH₃)₃SiO_{1/2})ₑ
   ((R²)CH₃SiO_{2/2})_{f}where R²=—(CH₂)₃C₆H₄OH
   ((C₆H₅)CH₃SiO_{2/2})_{f} and
   (C₆H₅SiO_{3/2})_{g},
II. carbinol functional silicone resins comprising the units:
   ((R¹)(CH₃)₂SiO_{1/2})ₑ where R¹=—(CH₂)₃C₆H₄OH and
   (C₆H₅SiO_{3/2})_{g},
III. carbinol functional silicone resins comprising the units:
   ((R¹)(CH₃)₂SiO_{1/2})ₑ where R¹=—(CH₂)₃C₆H₄OH and
   (CH₃SiO_{3/2})_{g},
IV. carbinol functional silicone resins comprising the units:
   ((R¹)(CH₃)₂SiO_{1/2})ₑ where R¹=—(CH₂)₃OH and
   (C₆H₅SiO_{3/2})_{g},
V. carbinol functional silicone resins comprising the units:
   ((R¹)(CH₃)₂SiO_{1/2})ₑ where R¹=—(CH₂)₃OH
   (CH₃SiO_{3/2})_{g} and
   (C₆H₅SiO_{3/2})_{g},
VI. carbinol functional silicone resins comprising the units:
   ((CH₃)₃SiO_{1/2})ₑ
   ((R²)CH₃SiO_{2/2})_{f}where R²=—(CH₂)₃OH
   ((C₆H₅)CH₃SiO_{2/2})_{f} and
   (C₆H₅SiO_{3/2})_{g},
VII. carbinol functional silicone resins comprising the units:
   ((CH₃)₃SiO_{1/2})ₑ
   ((R¹)(CH₃)₂SiO_{1/2})ₑ where R¹=—(CH₂)₃OH and
   (C₆H₅SiO_{3/2})_{g}, and
VIII. carbinol functional silicone resins comprising the units:
   ((R¹)(CH₃)₂SiO_{1/2})ₑ where R¹=—CH₂CH(CH₃)CH₂OH
   ((H)(CH₃)₂SiO_{1/2})ₑ and
   (C₆H₅SiO_{3/2})_{g},
wherein e is 0.3-0.5, f is 0-0.2, and g is 0.5-0.8.

Carbinol functional silicone resins can be prepared by reacting:
(A′) at least one hydrogen functional silicone resin comprising the units:
   (R¹′₃SiO_{1/2})ₑ (i)
   (R²′₂SiO_{2/2})_{f} (ii)
   (R³SiO_{3/2})_{g} (iii)
   and
   (SiO_{4/2})ₕ (iv)
where R^{1′} and R^{2′} are each independently an alkyl group having 1-8 carbon atoms, an aryl group, or a hydrogen atom; R³ is an alkyl group having 1-8 carbon atoms or an aryl group; e is less than 0.6; f is zero to 0.4; g is greater than zero; h is less than 0.5; the sum of e+f+g+h=1; provided that when each R^{2′} is methyl, the value of f is less than 0.3, and provided there are at least two silicon-bonded hydrogen atoms present in the silicone resin;
(B′) at least one vinyl terminated alcohol; in the presence of
(C′) a hydrosilylation catalyst; and optionally
(D′) at least one solvent.
   The Epoxy Functional Silicone Resin

The epoxy functional silicone resin contains epoxy functional groups or hydrolysis products thereof. Typically, however, the epoxy functional silicone resin contains the units:
(R⁷₃SiO_{1/2})ⱼ (i)
(R⁷₂SiO_{2/2})ₖ (ii)
(R⁷SiO_{3/2})ₗ and (iii)
(SiO_{4/2})ₘ. (iv)
where R⁷ is independently a monovalent hydrocarbon group or an epoxyfunctional substituted hydrocarbon group having 1-18 carbon atoms; j is greater than zero to 0.6; k is zero to 0.4; 1 is greater than zero; and m is less than 0.3. Typically, j is 0-0.4; k is 0-0.4; 1 is 0.5-0.8; m is zero; and the sum of j+j+1+m is one; provided that 0.1-30 mole percent alternatively 1 to 20 mole percent of the silicon atoms in the units (i), (i), or (iii), are monovalently attached to the hydrocarbon groups containing epoxy or the hydrolysis product.

Some examples of suitable R⁷ groups include methyl, propyl, isobutyl, octyl, phenyl, vinyl, 3-chloropropyl, 3,3,3-trifluoropropyl, 3-glycidoxypropyl, i.e., —(CH₂)₃—O—CH₂CH(O)CH₂, or its 1,2-diol. In lieu of the emulsification procedure set forth below, emulsions of silicone resins containing epoxy functional groups or their hydrolysis products can be obtained by emulsion polymerizing an appropriate alkoxysilane or a hydrolysis product thereof, optionally in the presence of a diorganosiloxane oligomer, in a catalyzed aqueous medium. The hydrolysis products of the epoxy, i.e. diols can occur in the emulsion form under hydrolytic conditions

Fluoroalkyl Acrylate Copolymers and Fluorinated Polyurethanes

While some benefits can be realized in treating fibers, textiles, and leather with only the silicone resin and/or the silicone resin emulsion, it is preferred to treat the fibers, textiles, and leather with the silicone resin and/or the silicone resin emulsion, in combination with either an emulsion containing either a fluoroalkyl acrylate copolymer or an emulsion containing a fluorinated polyurethane. Emulsions containing fluoroalkyl acrylate copolymers are commercially available from companies such as Bayer AG, Leverkusen, Germany, under their trademark BAYGARD® AFF 300; and Daikin Industries Ltd., Osaka, Japan, under their trademark UNIDYNE™ 470B and 571. Emulsions containing fluorinated polyurethanes are commercially available from companies such as E.I. DuPont de Nemours, Wilmington, Del., under their trademark ZONYL® 7910. An example of a suitable fluoroalkyl acrylate copolymer is shown below.

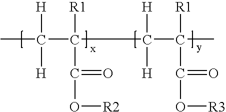

In the above structure, R1 is hydrogen or an alkyl group such as methyl; R2 represents a fluorocarbon group such as —(CH₂)ₙ(CF₂)₀CF₃; R3 represents an alkyl group such as —(CH₂)ₙCH₃; n is 0-5; o is 2-19; and x and y have values dependent upon the desired chain length.

Emulsification

Since one feature of the invention resides in using emulsions containing aminofunctional silicone resins, carbinol functional silicone resins, and epoxy functional silicone resins, and blending the silicone resin emulsions with emulsions containing fluoroalkyl acrylate copolymers or emulsions containing fluorinated polyurethanes, following is an emulsification procedure that can be used to prepare the silicone resin emulsions.

Component (A) of the silicone resin emulsion is the aminofunctional silicone resin, the carbinol functional silicone resin, or the epoxy functional silicone resin, each of which has been described above in detail. The amount of Component (A) in the silicone resin emulsion is typically from 5-60 percent by weight, based on the total weight of the silicone resin emulsion.

Component (B) of the silicone resin emulsion consists of at least one surfactant. The surfactant may be anionic, cationic, nonionic, or amphoteric. The surfactants may be employed separately, or in combinations of two or more.

Some examples of suitable anionic surfactants include alkali metal sulforicinates; sulfonated glyceryl esters of fatty acids such as sulfonated monoglycerides of coconut oil acids; salts of sulfonated monovalent alcohol esters such as sodium oleyl isethionate; amides of amino sulfonic acids such as the sodium salt of oleyl methyl tauride; sulfonated products of fatty acids nitriles such as palmitonitrile sulfonate; sulfonated aromatic hydrocarbons such as sodium alpha-naphthalene monosulfonate; condensation products of naphthalene sulfonic acids with formaldehyde; sodium octahydroanthracene sulfonate; alkali metal alkyl sulfates such as sodium lauryl sulfate, ammonium lauryl sulfate, and triethanolamine lauryl sulfate; ether sulfates having alkyl groups of 8 or more carbon atoms such as sodium lauryl ether sulfate, ammonium lauryl ether sulfate, sodium alkyl aryl ether sulfates, and ammonium alkyl aryl ether sulfates; alkylarylsulfonates having one or more alkyl groups of 8 or more carbon atoms; alkylbenzenesulfonic acid alkali metal salts such as hexylbenzenesulfonic acid sodium salt, octylbenzenesulfonic acid sodium salt, decylbenzenesulfonic acid sodium salt, dodecylbenzenesulfonic acid sodium salt, cetylbenzenesulfonic acid sodium salt, and myristylbenzenesulfonic acid sodium salt; sulfuric acid esters of polyoxyethylene alkyl ether such as CH₃(CH₂)₆CH₂O(C₂H₄O)₂SO₃H, CH₃(CH₂)₇CH₂O(C₂H₄O)_{3.5}SO₃H, CH₃(CH₂)₈CH₂O(C₂H₄O)₈SO₃H, CH₃(CH₂)₁₉CH₂O(C₂H₄O)₄SO₃H, and CH₃(CH₂)₁₀CH₂O(C₂H₄O)₆SO₃H; sodium salts; potassium salts; and amine salts of alkylnaphthylsulfonic acid.

Some examples of cationic surfactants include fatty acid amines and amides and their derivatives, and salts of the fatty acid amines and amides. Examples of suitable aliphatic fatty acid amines include dodecylamine acetate, octadecylamine acetate, and acetates of the amines of tallow fatty acids; homologues of aromatic amines having fatty acids such as dodecylanalin; fatty amides derived from aliphatic diamines such as undecylimidazoline; fatty amides derived from aliphatic diamines such as undecylimidazoline; fatty amides derived from disubstituted amines such as oleylaminodiethylamine; derivatives of ethylene diamine; quaternary ammonium compounds and their salts such as tallow trimethyl ammonium chloride, dioctadecyldimethyl ammonium chloride, didodecyldimethyl ammonium chloride, dihexadecyl ammonium chloride; alkyltrimethyl ammonium hydroxides such as octyltrimethyl ammonium hydroxide, dodecyltrimethyl ammonium hydroxide, and hexadecyltrimethyl ammonium hydroxide; dialkyldimethyl ammonium hydroxides such as octyldimethyl ammonium hydroxide, decyldimethyl ammonium hydroxide, didodecyldimethyl ammonium hydroxide, dioctadecyldimethyl ammonium hydroxide, tallow trimethyl ammonium hydroxide, coconut oil, trimethylammonium hydroxide, methylpolyoxyethylene cocoammonium chloride, and dipalmityl hydroxyethyl ammonium methosulfate; amide derivatives of amino alcohols such as beta-hydroxylethyl stearyl amide; and amine salts of long chain fatty acids.

Some examples of nonionic surfactants include polyoxyethylene alkyl ethers; polyoxyethylene alkylphenol ethers; polyoxyethylene lauryl ethers; polyoxyethylene sorbitan monoleates; polyoxyethylene alkyl esters; polyoxyethylene sorbitan alkyl esters; polyethylene glycol; polypropylene glycol; diethylene glycol; ethoxylated trimethylnonanols; and polyoxyalkylene glycol modified polysiloxane surfactants, i.e., silicone polyethers.

Examples of amphoteric surfactants that can be used include amino acid surfactants and betaine acid surfactants.

Some examples of commercially available surfactants include trimethylnonyl polyethylene glycol ethers and polyethylene glycol ether alcohols containing linear alkyl groups having from 11-15 carbon atoms such as 2,6,8-trimethyl-4-nonyloxypolyethylene oxyethanol (6 EO) sold as Tergitol® TMN-6 by The Dow Chemical Company, Midland, Mich.; 2,6,8-trimethyl-4-nonyloxypolyethylene oxyethanol (10 EO) sold as Tergitol® TMN-10 by The Dow Chemical Company, Midland, Mich.; alkylene-oxypolyethylene oxyethanol (C₁₁₋₁₅ secondary alkyl, 9 EO) sold as Tergitol® 15-S-9 by The Dow Chemical Company, Midland, Michigan; alkylene-oxypolyethylene oxyethanol (C₁₁₋₁₅ secondary alkyl, 15 EO) sold as Tergitol® 15-S-15 by The Dow Chemical Company, Midland, Mich., octylphenoxy polyethoxy ethanols having varying amounts of ethylene oxide units such as octylphenoxy polyethoxy ethanol (40 EO) sold as Triton® X405 by Rohm and Haas Company, Philadelphia, Pa.; nonionic ethoxylated tridecyl ethers available from Emery Industries, Mauldin, S.C. under the name Trycol; alkali metal salts of dialkyl sulfosuccinates available from American Cyanamid Company, Wayne, N.J., under the name Aerosol; polyethoxylated quaternary ammonium salts and ethylene oxide condensation products of primary fatty amines available from Armak Company, Chicago, Ill. under the names Ethoquad, Ethomeen, or Arquad; and polyoxyalkylene glycol modified polysiloxanes available from Dow Corning Corporation, Midland, Mich.

Other surfactants that can be used include surfactants derived from silicone; sorbitan derivatives; and fatty alcohol derivatives. Some suitable surfactants include sorbitan sesquioleate, sorbitan oleate, and sorbitan isostearate; alkoxylated alcohols such as ethoxylated fatty alcohols including Laureth-4, Laureth-7, Deceth-12, and Steareth-10; hydroxylated derivatives of polymeric silicones such as dimethicone copolyol; alkylated derivatives of hydroxylated polymeric silicones such as cetyl dimethicone copolyol; glyceryl esters such as polyglyceryl-4-isostearate; mixtures of such surfactants especially mixtures of hydroxylated derivatives of polymeric silicones, alkylated derivatives of hydroxylated polymeric silicones, and glyceryl esters, especially mixtures of dimethicone copolyol, cetyl dimethicone copolyol, and polyglyceryl-4-isostearate. Most preferred is a mixture of dimethicone copolyol, sorbitan sesquioleate, and Laureth-7.

The amount of surfactant Component (B) in the silicone resin emulsion is typically from 1-20 percent by weight, based on the total weight of the silicone resin emulsion.

Component (C) of the silicone resin emulsion is water. Generally, water is present at a level of 40-95 percent by weight, based on the total weight of the silicone resin emulsion.

The silicone resin emulsion can contain other ingredients such as fragrances; preservatives; ceramides; amino-acid derivatives; liposomes; polyols such as glycerin and propylene glycol; botanicals, i.e., plant extracts; conditioning agents such as quaternary polymers and silicones; glycols; vitamins such as vitamin A, vitamin C, vitamin E, and Pro-Vitamin B5; sunscreen agents including those which absorb ultraviolet light between about 290-320 nanometers, i.e., the UV-B region, and those which absorb ultraviolet light in the range of 320-400, i.e., the UV-B region; humectants; preservatives such as parabens; emollients; occlusive agents; esters; pigments; and agents for artificially tanning and/or browning the skin, i.e., self-tanning agents, such as dihydroxyacetone (DHA). These ingredients can be present in the silicone resin emulsion in an amount of 0.1-5 parts by weight per 100 parts by weight of the silicone resin emulsion, but typically are present in an amount of 0.1-1 part by weight per 100 parts by weight of the silicone resin emulsion. If desired, the silicone resin emulsion can be spray dried to form a resin/active composite particle.

Silicone resin emulsions can be prepared by mixing or mechanically agitating the Components (A)-(C) and any optional components and forming a homogenous mixture. This may be accomplished by any convenient mixing method using simple spatulas; mechanical stirrers; in-line mixing systems containing baffles and/or blades; powered in-line mixers; homogenizers; drum rollers; three-roll mills; sigma blade mixers; bread dough mixers; and two roll mills. The order of mixing of the various components is not critical.

Textile Treatment

The method of treating fibers, textiles, or leather generally comprises applying to fibers, textiles, or leather a hand improving effective amount of a treatment composition comprising a blend containing a silicone resin component and a fluorocarbon component. The fluorocarbon component consists of one or at least one of an emulsion containing a fluoroalkyl acrylate copolymer, or an emulsion containing a fluorinated polyurethane. The silicone resin component consists of one or at least one of (i) an aminofunctional silicone resin, (ii) an emulsion containing an aminofunctional silicone resin, (iii) a carbinol functional silicone resin, (iv) an emulsion containing a carbinol functional silicone resin, (v) an epoxy functional silicone resin, and (vi) an emulsion containing an epoxy functional silicone resin.

The fiber, textile, and/or leather treatment composition can be applied to the fiber, textile, leather by any convenient method. For example, the treatment composition can be applied by padding, dipping, spraying or exhausting. When the treatment composition comprises more than one solution, dispersion, or emulsion; the solutions, dispersions, and emulsions can be applied simultaneously, or sequentially to the textiles, fibers or leather. After the treatment composition is applied, it can be dried by heat.

The fiber, textile and leather treatment composition can be applied as the fibers, textiles, or leather is made or at a later stage such as during laundering of the textiles. After application, carriers if present can be removed from the treatment composition by drying the composition at an ambient or elevated temperature. The amount of treatment composition applied to the fibers, textiles, and leather is typically an amount sufficient to provide 0.1-15 weight percent of the treatment composition on the fibers, textiles, and leather, based on their dry weight, preferably an amount of 0.2-1 weight percent, based on the dry weight of the fiber, textile, or leather.

Fibers and textiles that can be treated with the treatment composition of the invention include natural fibers such as cotton, silk, linen, and wool; regenerated fibers such as rayon and acetate; synthetic fibers such as polyesters, polyamides, polyacrylonitriles, polyethylenes, and polypropylenes; and combinations or blends thereof. The fibers can be in the form of threads, filaments, tows, yarns, woven fabrics, knitted materials, non-woven materials, paper, or carpet. The leather that can be treated with the treatment composition of the present invention include natural and synthetic leather.

The treatment composition of the invention has several advantages such as imparting hydrophilicity to fibers; providing yellowing resistance to fibers; and providing hydrophilicity and yellowing resistance without significant detriment to the hand of the treated fibers. Hand for purposes of the invention means the softness and smoothness of the fabric.

Treatment of Textiles and Test Methods

Fabrics samples for testing were obtained from Testfabrics Incorporated, Pittston, Pa., and included 100 percent cotton twill Tribecka series khaki, and No. 7409 Dacron, 54 weight/Cotton, 65/35 Bleached Broadcloth, as standardized fabrics. Neither fabric had any prefinished coatings.

Oil Repellency:Hydrocarbon Resistance Test Protocol l—American Association of Textile Chemists & Colorists(AATCC) Test Method 118-1997

According to this test method, a series of oils are designated with numbers 1 to 8. The viscosity of the oils decrease as the oil number increases, i.e., a number 1 oil has a high viscosity compared to a number 8 oil which has a low viscosity. Each fabric is tested with the number 1 oil (Kaydol, i.e., mineral oil) up to the number 8 oil (n-heptane), and wetting or wicking into the fabric is noted. Values based on a rating scale of A, B, C, and D, are assigned to each oil, as an indication of the contact angle of the oil applied to the surface. Value C indicates wicking and wetting of the fabric, with full wicking of the fabric being assigned a rating value of D. Value A is the best, value B is passing, value C indicates failure, and value D is the worst. The test protocol consists of placing 5 drops of each of the numbered oils on the test fabric, waiting about 30 seconds, and then assigning a score for the oil. If the score is B or better, the next higher numbered oil is tested. A score of 8A is considered the best since it indicates that there was little or no wicking and/or wetting of the fabric even when using low viscosity oils.

Water Repellency: Spray Test—AATCC Test Method 22-1996

An AATCC spray tester was used to carry out this test method. The spray tester included a stand with a 45° incline. A separatory funnel having a spray nozzle attached to it was mounted above the incline. Fabric samples were fastened into a metal hoop and placed on the incline, and the nozzle was positioned about 6 inches above the hoop. 250 milliliter of distilled water was allowed to play down onto the fabric. The wetting pattern was compared to a standard rating scale. A rating of 100 was used to indicate no sticking or wetting of the upper surface; a rating of 90 was used to indicate slight random sticking or wetting of the upper surface; a rating of 80 was used to indicate wetting of the upper surface at the spray points; a rating of 70 was used to indicate partial wetting of the whole of upper surface; a rating of 50 was used to indicate complete wetting of the whole of the upper surface; and a rating of 0 was used to indicate complete wetting of the whole of the upper and lower surfaces.

Hand Testing

Samples were compared to a neat fabric on a scale of 0 to 5. The neat fabric was assigned a rating value of 2.0 based on the softness of the neat untreated fabric. A value of 5 was used to indicate maximum softness, and a value of 0 indicated lack of softness.

Coating Procedure—Resins in the Form of Neat samples Containing 100 Percent Solids

Two fluorocarbon emulsions were used in this coating procedure. One emulsion contained a fluoroalkyl acrylate copolymer, and the other emulsion contained a fluorinated polyurethane. The emulsion containing the fluoroalkyl acrylate copolymer was obtained from Bayer AG, Leverkusen, Germany, and was a composition sold under their trademark BAYGARD® AFF 300. The emulsion containing the fluorinated polyurethane was obtained from E.I. DuPont de Nemours, Wilmington, Delaware, and was a composition sold under their trademark ZONYL® 7910. Both of these emulsions are known to demonstrate good oil and water repellency for textiles made of all types of fibers and fiber blends. The emulsions were diluted down to a solids concentration of about one percent with de-ionized water. Swatches of test fabric were cut from single bolts of fabric into squares measuring 7″×7″.

A trough was constructed, and the emulsion was placed in the bottom so that each piece of fabric could be coated, as it was drawn through the trough. Immediately following application of the coating with the emulsion, the fabric sample was placed on a conveyer belt and fed through an oven. The oven was set at 300° C., and the residence time in the oven was set at about 3 minutes. Prior to application of the coating, each piece of fabric was fed through the oven to remove any residual water. The fabric was weighed prior to coating as well as after application of the coating, in order to calculate the absolute add on weights for each of the applied coatings. The fabric swatches were then allowed to sit for 24 hours before being coated with the aminofunctional silicone resin or the carbinol functional silicone resin.

The neat aminofunctional silicone resin and the neat carbinol functional silicone resin used in this coating procedure were dissolved in methyl isobutyl ketone (MIBK) at a solids level of about one percent, and the solution was used for application of a second coating to the fabric swatch. Again the dip coating trough was used, and the fabric swatches previously coated with the fluorocarbon emulsions were drawn through the fluid, and then air dried in a hood. The testing for oil and water repellency was completed 24 hours after application of the second coating. Neat pieces of fabric were also coated with the aminofunctional silicone resin and the carbinol functional silicone resin alone, and without the two fluorocarbon emulsions used in the first coating procedure. These test pieces were dip-coated in the trough in the same way as above using the silicone resin at a one percent solids level in an MIBK solution.

Coating Procedure —Resins in the Form of an Emulsion

The fluorocarbon containing emulsion and the silicone resin containing emulsion were added to an 8-ounce jar, and then diluted to a total weight of 100 gram. This treatment composition contained a final solids concentration of the fluorocarbon component of the blend of one percent by weight, and a final solids concentration of the silicone resin component of the blend of one percent by weight. A catalyst was added to the fluorocarbon emulsion/epoxy functional silicone resin emulsion blend, consisting of 0.05 gram of tetraisopropyl titanate (TPT) and 0.06 gram of ammonium phosphate. The emulsion blend was then placed in the bottom of a trough, and a 7″×7″ square fabric swatch sample was drawn through the trough to wet both sides of the fabric sample. Immediately following coating of the fabric sample with the fluorocarbon emulsion/silicone resin emulsion blend, the fabric sample was placed on a conveyer belt arranged to travel through an oven. The oven was set to maintain a temperature of 300° C., and the speed of travel of the conveyor belt was adjusted to maintain a residence time in the oven of about 3 minutes. Prior to coating of the fabric sample, each piece of fabric was passed through the oven to remove any residual water. The fabric sample was weighed prior to application of the coating and after application of the coating, to calculate the absolute add on weight of each of the coatings. The fabric swatches were then allowed to sit for 24 hours before completion of the testing.

### EXAMPLES

The following examples illustrate the invention in more detail. In these examples, the composition of the silicone resins has been expressed in terms of various combinations of one or more of the following structural units:
M is (CH₃)₃SiO_{1/2}
M^{NH2} is H₂NCH₂CH₂CH₂(CH₃)₂SiO_{1/2}
M^{PrOH} is (HOCH₂CH₂CH₂)(CH₃)₂SiO_{1/2}
M^{Phenol} is (HOC₆H₄CH₂CH₂CH₂)(CH₃)₂SiO_{1/2}
D^{Me} is (CH₃)₂SiO_{2/2}
T^{Me} is CH₃SiO_{3/2}
T^{Ph} is C₆H₅SiO_{3/2}
T^{Pr} is C₃H₇SiO_{3/2}
T^{NH2} is H₂NCH₂CH₂CH₂SiO_{3/2} and
T^{Glycidoxy Pr} is CH₂(O)CHCH₂OCH₂CH₂CH₂SiO_{3/2} or
CH₂OHCHOHCH₂OCH₂CH₂CH₂SiO_{3/2}

In the Tables accompanying each example, Fluorocarbon A is ZONYL® 7910, an emulsion containing a fluorinated polyurethane. Fluorocarbon B is BAYGARD® AFF 300, an emulsion containing a fluoroalkyl acrylate copolymer. Fluorocarbon C is UNIDYNE™ 470B, an emulsion containing a fluoroalkyl acrylate copolymer. Fluorocarbon D is UNIDYNE™ 571, an emulsion containing a fluoroalkyl acrylate copolymer. The amounts indicated in the Tables in terms of percent (%), are the percent by weight of solids present in the coating based on the weight of the fabric that was coated.

### Example 1

The coating procedure explained in detail above for resins in the form of neat samples containing 100 percent by weight of solids, was used as the coating technique in this example. The following silicone resins were used in the example:
(i) Resin A was an aminofunctional silicone resin with low amine content, and a structure corresponding to M_{0.088}T^{NH2}_{0.025}T^{Pr}_{0.887}.
(ii) Resin B was a carbinol functional silicone resin with a structure corresponding to M^{PrOH}_{0.355}T^{Me}_{0.314}T^{Ph}_{0.314}.
(iii) Resin C was a carbinol functional silicone resin with a structure corresponding to M^{PrOH}_{0.502}T^{Me}_{0.450}.
(iv) Resin D was a carbinol functional silicone resin with a structure corresponding to M_{0.262}M^{Phenol}_{0.093}T^{Ph}_{0.628}.

Tables 1 and 2 show the test results obtained using coatings containing compositions according to the present invention.

TABLE 1
Coatings Applied to 100 Percent Cotton
Twill Tribecka Series Khaki

| | Oil | Water | |
|---|---|---|---|
| Coating | Repellency | Repellency | Hand |
| (a) No Coating Applied | 0 | 0 | 2 |
| (b) 1% Fluorocarbon A | 3A, 4C | 75 | 1 |
| (c) 1% Fluorocarbon B | 5A, 6B, 7D | 75 | 1 |
| (d) 1% Fluorocarbon A, 1% Resin A | 5A, 7B | 65 | 3 |
| (e) 1% Fluorocarbon A, 1% Resin B | 6A, 7B | 65 | 2 |
| (f) 1% Fluorocarbon A, 1% Resin C | 5A, 7B | 70 | 2 |
| (g) 1% Fluorocarbon A, 1% Resin D | 5A, 7B | 70 | 2 |
| (h) 1% Fluorocarbon B, 1% Resin A | 3A, 4B, 5B | 100 | 2 |
| (i) 1% Fluorocarbon B, 1% Resin B | 3A, 4B | 95 | 4 |
| (j) 1% Fluorocarbon B, 1% Resin C | 3A, 4B | 75 | 3 |
| (k) 1% Fluorocarbon B, 1% Resin D | 3A, 5B, 6B | 100 | 3 |

TABLE 2
Coatings Applied to a No. 7409 Dacron, 54
weight/Cotton, 65/35 Bleached Broadcloth

| | Oil | Water | |
|---|---|---|---|
| Coating | Repellency | Repellency | Hand |
| (a) No Coating Applied | 0 | 0 | 2 |
| (b) 1% Fluorocarbon A | 5A, 6B, 7D | 70 | 1 |
| (c) 1% Fluorocarbon B | 6A, 7B, 8D | 80 | 1 |
| (d) 1% Fluorocarbon A, 1% Resin A | 5A, 6B, 7B, | 65 | 3 |
| | 8B | | |
| (e) 1% Fluorocarbon A, 1% Resin B | 6A, 8B | 75 | 2 |
| (f) 1% Fluorocarbon A, 1% Resin C | 6A, 7B | 75 | 2 |
| (g) 1% Fluorocarbon A, 1% Resin D | 6A, 8B | 75 | 2 |
| (h) 1% Fluorocarbon B, 1% Resin A | 5A, 6B | 100 | 3 |
| (i) 1% Fluorocarbon B, 1% Resin B | 5A, 6B, 7B | 100 | 3 |
| (j) 1% Fluorocarbon B, 1% Resin C | 5A, 7B | 95 | 2 |
| (k) 1% Fluorocarbon B, 1% Resin D | 5A, 6B | 100 | 3 |

Tables 1 and 2 show that significant improvements can be realized using coatings containing the compositions of the invention. For example, in Table 1, all coatings of the invention provided an improvement in Hand over the fluorocarbons alone. In Table 2, all of the coatings of the invention provided an improvement in Hand over the fluorocarbons alone. Coatings (h), (i), and (k) also provided 100 Percent Water Repellency.

### Example 2

The coating procedure explained in detail above for resins in the form of an emulsion was used as the coating technique in this example. The following emulsion containing a silicone resin was used in the example:

Emulsion A contained an epoxy functional silicone resin having a structure corresponding to M_{0.1}D^{Me}_{0.12}T^{Me}_{0.67}T^{GlycidxyPr}_{0.11} that was emulsified using a blend of a cationic surfactant and a nonionic surfactant.

TABLE 3
Coatings Applied to 100 Percent Cotton
Twill Tribecka Series Khaki

| | | Oil | Water | |
|---|---|---|---|---|
| Coating | | Repellency | Repellency | Hand |
| (a) | No Coating Applied | 0 | 0 | 2 |
| (b) | 1% Fluorocarbon C | 5A, 6B | 100 | 2 |
| (c) | 1% Fluorocarbon C, | 5A, 7B | 100 | 3 |
| | 1% Emulsion A | | | |
| (d) | 1% Fluorocarbon D | 5A, 6B | 100 | 1 |
| (e) | 1% Fluorocarbon D, | 5A, 6B | 100 | 2 |
| | 1% Emulsion A | | | |

Table 3 shows that equivalent oil repellency can be obtained using the coating of the invention, and that the coating of the invention provides an improvement in Hand over the flurocarbon alone.

Other variations may be made in compounds, compositions, and methods described herein without departing from the essential features of the invention. The embodiments of the invention specifically illustrated herein are exemplary only and not intended as limitations on their scope except as defined in the appended claims.

1. A method of treating fibers, textiles, or leather comprising applying to fibers, textiles, or leather 0.1-15 weight percent based on the weight of the fibers, textiles, or leather of a treatment composition comprising a blend containing a silicone resin component and a fluorocarbon component; the fluorocarbon component comprising one of an emulsion containing a fluoroalkyl acrylate copolymer or an emulsion containing a fluorinated polyurethane; the silicone resin component comprising one of (i) an aminofunctional silicone resin, (ii) an emulsion containing an aminofunctional silicone resin, (iii) a carbinol functional silicone resin, (iv) an emulsion containing a carbinol functional silicone resin, (v) an epoxy functional silicone resin, or (vi) an emulsion containing an epoxy functional silicone resin.

2. A method of treating fibers, textiles, or leather comprising applying to fibers, textiles, or leather 0.1-15 weight percent based on the weight of the fibers, textiles, or leather of a treatment composition comprising a blend containing a silicone resin component and a fluorocarbon component; the fluorocarbon component comprising at least one of an emulsion containing a fluoroalkyl acrylate copolymer or an emulsion containing a fluorinated polyurethane; the silicone resin component comprising at least one of (i) an aminofunctional silicone resin, (ii) an emulsion containing an aminofunctional silicone resin, (iii) a carbinol functional silicone resin, (iv) an emulsion containing a carbinol functional silicone resin, (v) an epoxy functional silicone resin, or (vi) an emulsion containing an epoxy functional silicone resin.

3. A method according to claim 2 in which the aminofunctional silicone resin comprises the units:
(R₃SiO_{1/2})ₐ (i)
(R₂SiO_{2/2})_{b} (ii)
(R₂SiO_{3/2})_{c} and (iii)
(SiO_{4/2})_{d} (iv)
where R is independently an alkyl group, an aryl group, or an aminofunctional hydrocarbon group; a is greater than zero to 0.5; b is zero to 0.4; c is greater than zero to 0.93; d is less than 0.3; and the sum of a+b+c+d is one.

4. A method according to claim 2 in which the aminofunctional silicone resin is a resin containing units selected from the group consisting of:
I. the units:
((CH₃)₃SiO_{1/2})ₐ (i)
(C₆H₅(CH₃)SiO_{2/2})_{b} (ii)
((CH₃)RSiO_{2/2})_{b} (iii)
(C₆H₅SiO_{3/2})_{c}, (iv)
II. the units:
((CH₃)₃SiO_{1/2})ₐ (i)
((CH₃)RSiO_{2/2})_{b} (ii)
(RSiO_{3/2})_{c} (iii)
(C₆H₅SiO_{3/2})_{c}, (iv)
III. the units:
((CH₃)₃SiO_{1/2})ₐ (i)
((CH₃)RSiO_{2/2})_{b} (ii)
(C₆H₅SiO_{3/2})_{c}, and (iii)
V. the units:
((CH₃)₃SiO_{1/2})ₐ (i)
(C₆H₅(CH₃)SiO_{2/2})_{b} (ii)
((CH₃)RSiO_{2/2})_{b} (iii)
(C₆H₅SiO_{3/2})_{c} (iv)
(SiO_{4/2})_{d}, (v)
wherein a, b, c, and d, are as defined above, and R is —CH₂CH₂CH₂NH₂.

5. A method according to claims 2 in which the carbinol functional silicone resin comprises the units:
(R¹₃SiO_{1/2})ₑ (i)
(R²₂SiO_{2/2})_{f} (ii)
(R³SiO_{3/2})_{g} and (iii)
(SiO_{4/2})ₕ (iv)
where R¹ and R² are independently a hydrogen atom, an alkyl group having 1-8 carbon atoms, an aryl group, a carbinol group having at least 3 carbon atoms and being free of aryl groups, or an aryl-containing carbinol group having at least 6 carbon atoms; R³ is an alkyl group having 1-8 carbon atoms or an aryl group; e is less than 0.6; f is zero to 0.4; g is greater than zero; h is less than 0.5; the value of e+f+g+h is one; provided that when each R² is methyl, the value of f is less than 0.3.

6. A method according to claim 2 in which the carbinol functional silicone resin is a resin containing units selected from the group consisting of:
I. the units:
((CH₃)₃SiO_{1/2})ₑ
((R²)CH₃SiO_{2/2})_{f} where R²=—(CH₂)₃C₆H₄OH
((C₆H₅)CH₃SiO_{2/2})f and
(C₆H₅SiO_{3/2})_{g},
II. the units:
((R¹)(CH₃)₂SiO_{1/2})ₑ where R¹=—(CH₂)₃C₆H₄OH and
(C₆H₅SiO_{3/2})_{g},
III the units:
((R¹)(CH₃)₂SiO_{1/2})ₑ where R¹=—(CH₂)₃C₆H₄OH and
(CH₃SiO_{3/2})_{g},
IV. the units:
((R¹)(CH₃)₂SiO_{1/2})ₑ where R¹=—(CH₂)₃OH and
(C₆H₅SiO_{3/2})_{g},
V. the units:
((R¹)(CH₃)₂SiO_{1/2})ₑ where R¹=—(CH₂)₃OH
(CH₃SiO_{3/2})_{g} and
(C₆H₅SiO_{3/2})_{g},
VI. the units:
((CH₃)₃SiO_{1/2})ₑ
((R²)CH₃SiO_{2/2})_{f} where R²=—(CH₂)₃OH
((C₆H₅)CH₃SiO_{2/2})_{f}and
(C₆H₅SiO_{3/2})_{g},
VII. the units:
((CH₃)₃SiO_{1/2})ₑ
((R¹)(CH₃)₂SiO_{1/2})ₑ where R¹=—(CH₂)₃OH and
(C₆H₅SiO_{3/2})_{g}, and
VIII the units:
((R¹)(CH₃)₂SiO_{1/2})ₑ where R¹=—CH₂CH(CH₃)CH₂OH
((H)(CH₃)₂SiO_{1/2})ₑ and
(C₆H₅SiO_{3/2})_{g},
where e is 0.3-0.5, f is 0-0.2, g is 0.5-0.8, and h is zero.

7. A method according to claim 2 in which the epoxy functional silicone resin comprises the units:
(R⁷₃SiO_{1/2})ⱼ (i)
(R⁷₂SiO_{2/2})ₖ (ii)
(R⁷SiO_{3/2})ₗ and (iii)
(SiO_{4/2})ₘ. (iv)
where R⁷ is independently a monovalent hydrocarbon group or an epoxyfunctional substituted hydrocarbon group having 1-18 carbon atoms; j is greater than zero to 0.6; k is zero to 0.4; 1 is greater than zero; and m is less than 0.3, the sum of j+k+l+m is equal to one; provided that 0.1-30 mole percent of silicon atoms in units (i), (ii), or (iii), are monovalently attached to the hydrocarbon groups containing epoxy or hydrolysis products thereof.

8. A composition for treating fibers, textiles, or leather comprising a blend containing a silicone resin component and a fluorocarbon component; the fluorocarbon component comprising one of an emulsion containing a fluoroalkyl acrylate copolymer, or an emulsion containing a fluorinated polyurethane; the silicone resin component comprising one of (i) an aminofunctional silicone resin, (ii) an emulsion containing an aminofunctional silicone resin, (iii) a carbinol functional silicone resin, (iv) an emulsion containing a carbinol functional silicone resin, (v) an epoxy functional silicone resin, or (vi) an emulsion containing an epoxy functional silicone resin.

9. A composition for treating fibers, textiles, or leather comprising a blend containing a silicone resin component and a fluorocarbon component; the fluorocarbon component comprising at least one of an emulsion containing a fluoroalkyl acrylate copolymer or an emulsion containing a fluorinated polyurethane; the silicone resin component comprising at least one of (i) an aminofunctional silicone resin, (ii) an emulsion containing an aminofunctional silicone resin, (iii) a carbinol functional silicone resin, (iv) an emulsion containing a carbinol functional silicone resin, (v) an epoxy functional silicone resin, or (vi) an emulsion containing an epoxy functional silicone resin.

10. A composition according to claim 9 in which the aminofunctional silicone resin comprises the units:
(R₃SiO_{1/2})ₐ (i)
(R₂SiO_{2/2})_{b} (ii)
(RSiO_{3/2})_{c} and (iii)
(SiO_{4/2})_{d} (iv)
where R is independently an alkyl group, an aryl group, or an aminofunctional hydrocarbon group; a is greater than zero to 0.4; b is zero to 0.4; c is greater than zero to 0.93; d is less than 0.3; and the sum of a+b+c+d is one.

11. A composition according to claim 9 in which the aminofunctional silicone resin is a resin containing units selected from the group consisting of:
I. the units:
((CH₃)₃SiO_{1/2})ₐ (i)
(C₆H₅(CH₃)SiO_{2/2})_{b} (ii)
((CH₃)RSiO_{2/2})_{b} (iii)
(C₆H₅SiO_{3/2})_{c}, (iv)
II. the units:
((CH₃)₃SiO_{1/2})ₐ (i)
((CH₃)RSiO_{2/2})_{b} (ii)
(RSiO_{3/2})_{c} (iii)
(C₆H₅SiO_{3/2})_{c}, (iv)
III. the units:
((CH₃)₃SiO_{1/2})ₐ (i)
((CH₃)RSiO_{2/2})_{b} (ii)
(C₆H₅SiO_{3/2})_{c}, and (iii)
IV. the units:
((CH₃)₃SiO_{1/2})ₐ (i)
(C₆H₅(CH₃)SiO_{2/2})_{b} (ii)
((CH₃)RSIO_{2/2})_{b} (iii)
(C₆H₅SiO_{3/2})_{c} (iv)
(SiO_{4/2})_{d}; (v)
wherein a, b, c, and d, are as defined above, and R is —CH₂CH₂CH₂NH₂.

12. A composition according to claim 9 in which the carbinol functional silicone resin comprises the units:
(R¹₃SiO_{1/2})ₑ (i)
(R²₂SiO_{2/2})_{f} (ii)
(R³SiO_{3/2})_{g} and (iii)
(SiO_{4/2})ₕ (iv)
where R¹ and R² are independently a hydrogen atom, an alkyl group having 1-8 carbon atoms, an aryl group, a carbinol group having at least 3 carbon atoms and being free of aryl groups, or an aryl-containing carbinol group having at least 6 carbon atoms; R³ is an alkyl group having 1-8 carbon atoms or an aryl group; e is less than 0.6; f is zero to 0.4; g is greater than zero; h is less than 0.5; the value of e+f+g+h is one; provided that when each R² is methyl, the value of f is less than 0.3.

13. A composition according to claim 9 in which the carbinol functional silicone resin is a resin containing units selected from the group consisting of:
I. the units:
((CH₃)₃SiO_{1/2})ₑ
((R²)CH₃SiO_{2/2})_{f} where R²=—(CH₂)₃C₆H₄OH
((C₆H₅)CH₃SiO_{2/2})f and
(C₆H₅SiO_{3/2})_{g},
II. the units:
((R¹)(CH₃)₂SiO_{1/2})ₑ where R¹=—(CH₂)₃C₆H₄OH and
(C₆H₅SiO_{3/2})_{g},
III. the units:
((R¹)(CH₃)₂SiO_{1/2})ₑ where R¹=—(CH₂)₃C₆H₄OH and
(CH₃SiO_{3/2})_{g},
IV. the units:
((R¹)(CH₃)₂SiO_{1/2})ₑ where R¹=—(CH₂)₃OH and
(C₆H₅SiO_{3/2})_{g},
V. the units:
((R¹)(CH₃)₂SiO_{1/2})ₑ where R¹=—(CH₂)₃OH
(CH₃SiO_{3/2})_{g} and
(C₆H₅SiO_{3/2})_{g},
VI. the units:
((CH₃)₃SiO_{1/2})ₑ
((R²)CH₃SiO_{2/2})_{f} where R²=—(CH₂)₃OH
((C₆H₅)CH₃SiO_{2/2})_{f} and
(C₆H₅SiO_{3/2})_{g},
VII. the units:
((CH₃)₃SiO_{1/2})ₑ
((R¹)(CH₃)₂SiO_{1/2})ₑ where R¹=—(CH₂)₃OH and
(C₆H₅SiO_{3/2})_{g}, and
VIII. the units:
((R¹)(CH₃)₂SiO_{1/2})ₑ where R¹=—CH₂CH(CH₃)CH₂OH
((H)(CH₃)₂SiO_{1/2})_{e and}
(C₆H₅SiO_{3/2})_{g},
where e is 0.3-0.5, f is 0-0.2, g is 0.5-0.8, and h is zero.

14. A composition according to claim 9 in which the epoxy functional silicone resin comprises the units:
(R⁷₃SiO_{1/2})ⱼ (i)
(R⁷₂SiO_{2/2})ₖ (ii)
(R⁷SiO_{3/2})ₗ and (iii)
(SiO_{4/2})ₘ. (iv)
R⁷ is independently a monovalent hydrocarbon group or an epoxyfunctional substituted hydrocarbon group having 1-18 carbon atoms; j is greater than zero to 0.6; k is zero to 0.4; 1 is greater than zero; and m is less than 0, the sum of j+k+l+m is equal to one; provided that 0.1-30 mole percent of silicon atoms in units (i), (ii), or (iii), are monovalently attached to the hydrocarbon groups containing epoxy or hydrolysis products thereof.
